(19) United States
(12) Patent Application Publication
(10) Pub. No.: US 2017/0170585 A1
(43) Pub. Date: Jun. 15, 2017

(54) Connector for Flat Conductor

(71) Applicant: IRISO ELECTRONICS CO., LTD., Yokohama (JP)

(72) Inventor: Hiroaki Yukutake, Yokohama (JP)

(73) Assignee: IRISO ELECTRONICS CO., LTD., Yokohama (JP)

(21) Appl. No.: 15/364,405

(22) Filed: Nov. 30, 2016

(30) Foreign Application Priority Data
Dec. 10, 2015 (JP) 2015-241250

(51) Int. Cl. H01R 12/72; H01R 13/24

(52) U.S. Cl. CPC H01R 12/721; H01R 13/2407

(57) ABSTRACT

A second terminal includes a base portion extending along a bottom surface of a fitting chamber from a side of an opening of the fitting chamber toward a depth wall. The base portion includes a fixed piece fixed to the bottom surface and a movable piece that turns on the fixed piece as the turning fulcrum in a direction away from the bottom surface. The second terminal utilizes the total length of a spring piece portion and the movable piece as the spring length for elastically displacing a contact part.

### BACKGROUND OF THE INVENTION

1. Field of the Invention

The present invention relates to a connector that connects a flat conductor to a substrate or the like.

2. Description of the Related Art

A connector for a flat conductor is used to conductively connect a flat conductor serving as a connection object member to a circuit of a substrate. For example, a so-called card edge connector (see Japanese Unexamined Patent Application Publication No. 9-306606) is used to connect a flat conductor formed by a hard substrate such as a memory card, an IC card, or a graphic board. In such a card edge connector (hereinafter simply referred to as “connector”), after a flat conductor is obliquely inserted into a fitting chamber of a housing, it is turned on an inserted leading edge so as to be parallel with a mounting board of the connector. Thus, contact portions of the flat conductor come into conductive contact with contact portions of terminals projecting in the fitting chamber to achieve connection between boards.

Such a connector for a flat conductor has a problem in that the inserting/removing force is large. For example, there is a flat conductor having 200 or more poles like a graphic board. When the number of poles of the flat conductor is large in this way, the number of terminals of the connector is also large. This increases the number of contact portions required to be bent when the flat conductor is inserted. Hence, insertion and removal of the flat conductor into and from the connector are tightened, and operability deteriorates. The number of terminals tends to increase as the function of an information processing apparatus, such as a computer, is diversified and sophisticated and the number of signals to be processed by the board increases. Hence, the need to reduce the inserting/removing force for the flat conductor is growing in the field of card edge connectors.

### SUMMARY OF THE INVENTION

The present invention has been made in the context of the related art described above, and an object of the invention is to reduce the force for inserting and removing a flat conductor into and from a connector for the flat conductor.

To achieve the above object, the present invention is configured as follows.

A connector for a flat conductor according to an aspect of the present invention includes a housing having a fitting chamber for the flat conductor and a terminal to be in conductive contact with the flat conductor inserted in the fitting chamber. The terminal includes a base portion extending along a bottom surface of the fitting chamber from an open side of the fitting chamber to a depth side of the fitting chamber, and a spring piece portion having a contact part to be in conductive contact with the flat conductor inserted in the fitting chamber and extending from the base portion above the bottom surface. The base portion includes a fixed piece fixed to the bottom surface on the open side and a movable piece configured to turn on an end portion of the fixed piece on the depth side in a direction away from the bottom surface.

According to this structure, the terminal includes the base portion extending along the bottom surface of the fitting chamber and the spring piece portion extending above the bottom surface and having the contact part, and the spring piece portion is entirely raised from the bottom surface of the fitting chamber to function as a spring for elastically supporting the contact part. Moreover, in the present invention, the base portion of the terminal extending along the bottom surface of the fitting chamber has the movable piece that turns on the end portion of the fixed piece on the depth side in the direction away from the bottom surface. The movable piece functions as the spring for elastically supporting the contact part. Therefore, the sum of the length of the movable piece along the bottom surface of the fitting chamber and the length of the spring piece portion extending above the bottom surface can be utilized as the length of the spring for elastically displacing the contact part. Hence, according to this structure, the terminal can be softly displaced. This reduces the insertion force for the flat conductor and enhances operability of connection of the flat conductor.

Preferably, the spring piece portion has a first bent part bent from an end portion of the movable piece on the depth side toward the open side, and the first bent part serves as a turning fulcrum on which the contact part turns in sliding contact with the flat conductor toward the open side of the fitting chamber when the contact part is displaced toward the base portion by being pressed by the flat conductor inserted in the fitting chamber.

According to this structure, the contact part that is displaced toward the base portion by being pressed by the flat conductor is not simply displaced by being pushed down toward the base portion, but can be turned on the first bent part serving as the turning fulcrum toward the open side of the fitting chamber. Therefore, the distance of sliding contact of the contact part with the flat conductor can be made longer by a superposition effect of the turn of the movable piece of the base portion and the turn of the first bent part toward the open side of the fitting chamber than when the base portion is entirely fixed to the bottom surface. Hence, according to this structure, a substance attached to the flat conductor can be wiped off over a wide range. This enhances reliability of connection to a flat conductor having a large number of poles.

The spring piece portion may further include an extending part extending from the first bent part toward the open side and a second bent part bent from an end portion of the extending part on the open side toward the depth side to be connected to the contact part.

According to this structure, since the length of the extending part and the length of the second bent part can be utilized as the spring length, the spring length from the movable piece of the base portion to the contact part increases, and the terminal can softly touch the flat conductor. This can reduce the insertion force for the flat conductor.

### BRIEF DESCRIPTION OF THE DRAWINGS

FIG. 1 is an external perspective view including a front surface, a top surface, and a right side surface of a connector for a flat conductor according to an embodiment of the present invention.

FIG. 2 is a front view of the connector of FIG. 1.

FIG. 3 is an enlarged view of a section A in FIG. 2.

FIG. 4 is an external perspective view of a first terminal provided in the connector of FIG. 1.

FIG. 5 is an external perspective view of a second terminal provided in the connector of FIG. 1.

FIG. 6 is a cross-sectional view taken along line VI-VI of FIG. 3.

FIG. 7 is an explanatory view illustrating a fitting process of a flat conductor subsequent to the state of FIG. 6.

FIG. 8 is an explanatory view illustrating a fitting state of the flat conductor subsequent to the state of FIG. 7.

FIGS. 9A to 9C are schematic cross-sectional views illustrating a fitting process of the flat conductor corresponding to FIGS. 6 to 8, FIG. 9A is an explanatory view comparing the terminal (solid line) before the flat conductor is inserted and the terminal (two-dot chain line) in a state in which the flat conductor is inserted, FIG. 9B is an explanatory view comparing the terminal (solid line) in a state in which the flat conductor is inserted and a terminal (two-dot chain line) in a comparative example in which a movable piece does not turn, and FIG. 9C is an explanatory view of the terminal fitted to the flat conductor.

### DESCRIPTION OF THE PREFERRED EMBODIMENTS

A connector for a flat conductor according to an embodiment of the present invention will be described below with reference to the drawings. In the description of the embodiment, a card edge connector is given as an example of a connector for a flat conductor. A flat conductor to be connected is a hard substrate P1.

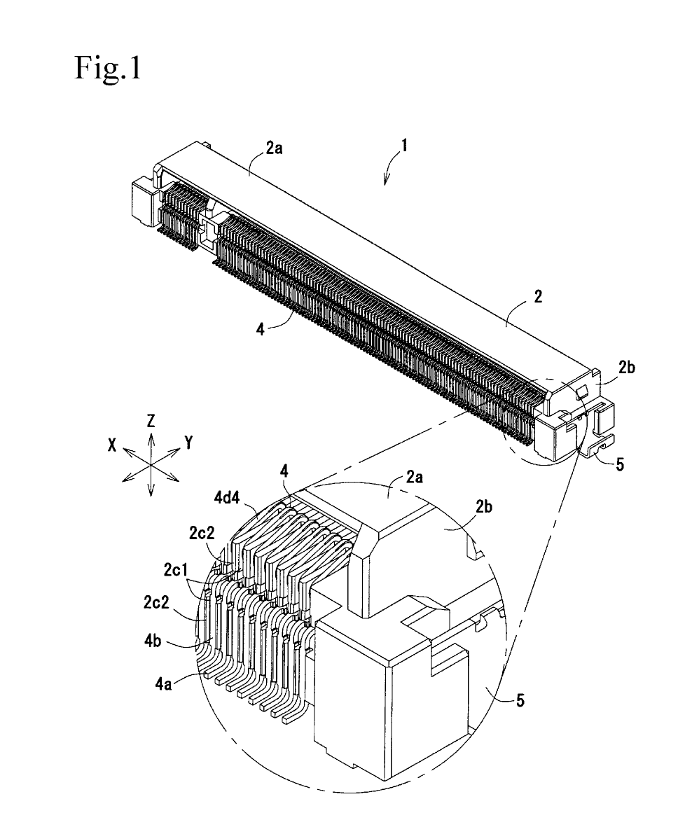

In the specification, the claims, and the drawings, a width direction, a front-rear direction, and a height direction of a card edge connector 1 illustrated in FIG. 1 (hereinafter simply referred to as “connector 1”) are respectively taken as an X-direction, a Y-direction, and a Z-direction. A top surface and a bottom surface in the height direction Z are taken as an “upper” surface and a “lower” surface, respectively. Further, a front surface and a rear surface in the front-rear direction Y are taken as a “front” surface and a “rear” surface, respectively. Such definitions of upper, lower, front, and rear do not limit the mounting direction and use direction of the connector of the embodiment.

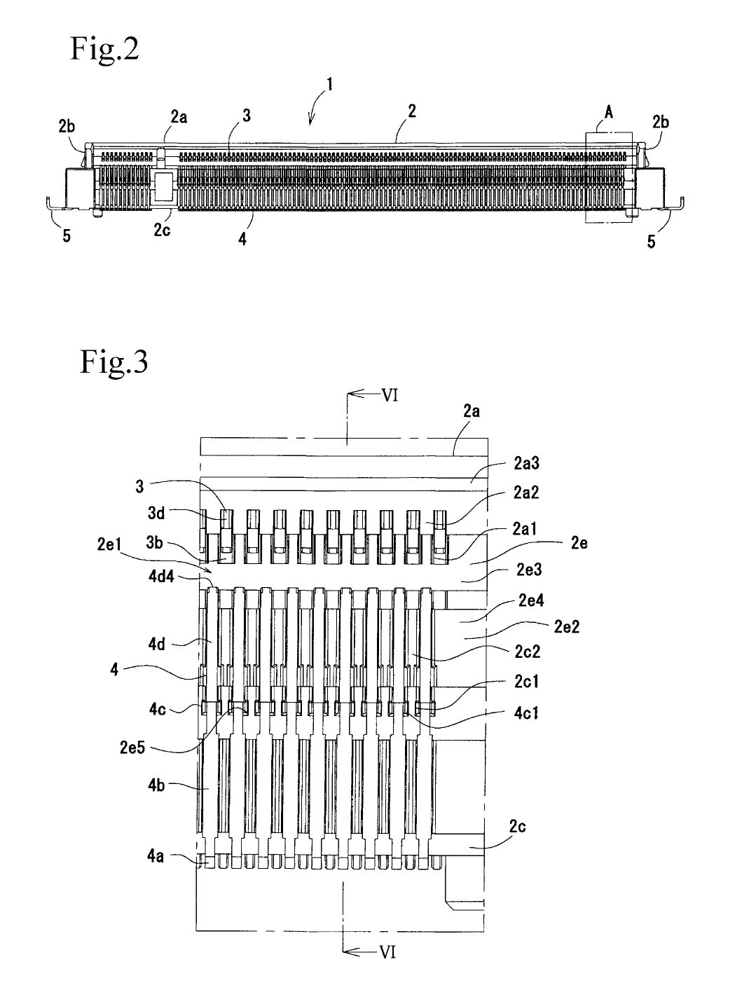

### Structure of Connector 1 (FIGS. 1 to 5)

The connector 1 includes a housing 2 that extends long in the width direction X. The housing 2 has an upper wall 2a, right and left side walls 2b, a bottom wall 2c, and a rear wall 2d that are rectangular.

In an inner side surface of the upper wall 2a of these walls, first-terminal attachment grooves 2a1 to which first terminals 3 are attached are provided along the front-rear direction Y of the connector 1 (FIG. 3). The adjacent first terminals 3 are arranged while being structurally isolated by a partitioning wall 2a2 that defines the first-terminal attachment grooves 2a1. Similarly, second-terminal attachment grooves 2c1 to which second terminals 4 are attached are provided in the bottom wall 2c. The adjacent second terminals 4 are arranged while being structurally isolated by a partitioning wall 2c2 that defines the second-terminal attachment grooves 2c1. The connector 1 of the embodiment has 230 first terminals 3 and 230 second terminals 4. For this reason, the connector 1 is configured as a multipole connector in which the insertion force of the hard substrate P1 is likely to be large.

Inside the housing 2, a fitting chamber 2e is provided. In the fitting chamber 2e, the hard substrate P1 is inserted into conductive connection with the first terminals 3 and the second terminals 4. The fitting chamber 2e is formed by an inner space surrounded by inner walls of the housing 2. Specifically, the fitting chamber 2e is formed as an inner space surrounded by inner side surfaces of the upper wall 2a, the side walls 2b, the bottom wall 2c, and the rear wall 2d described above.

On a front side of the fitting chamber 2e, an opening 2e1 is provided as an insertion hole for the hard substrate P1 serving as the flat conductor. On a depth side (rear side) of the fitting chamber 2e, a depth wall 2e2 is provided as an inner side surface of the rear wall 2d. On a front inner side surface of the upper wall 2a that defines the fitting chamber 2e, an insertion guide surface 2a3 is provided to guide insertion of the hard substrate P1. Groove bottom faces of the above-described second-terminal attachment grooves 2c1 form a bottom surface 2e5 of the fitting chamber 2e.

The fitting chamber 2e is divided into an upper fitting chamber 2e3 and a lower fitting chamber 2e4 according to the difference in depth from the opening 2e1. The upper fitting chamber 2e3 is provided as an accommodating space for the hard substrate P1 in a fitted state. The lower fitting chamber 2e4 is provided as a displacement space for the second terminals 4 to be described later, and is deeper toward the depth side of the fitting chamber 2e (toward the depth wall 2e2) than the upper fitting chamber 2e3 so that a long spring length can be ensured.

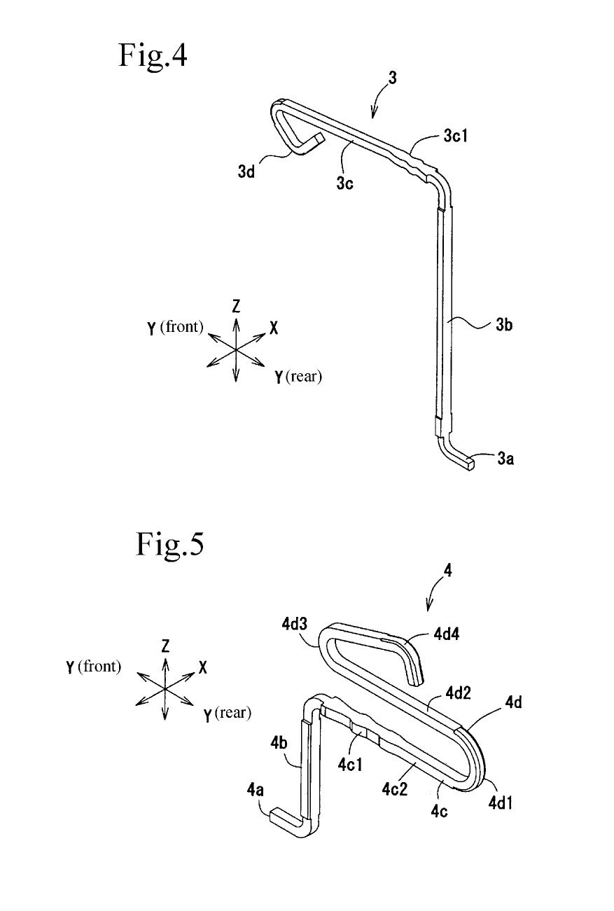

As illustrated in the external view of FIG. 4, each of the first terminals 3 includes a substrate connecting portion 3a to be soldered to a mounting board P2, a vertical piece portion 3b extending along the height direction of the rear wall 2d of the housing 2, a horizontal piece portion 3c extending frontward from the vertical piece portion 3b, and a contact portion 3d bent downward from a front end of the horizontal piece portion 3c.

The first terminal 3 is inserted in the corresponding first-terminal attachment groove 2a1 from the rear side of the rear wall 2d of the housing 2, and is fixed by press-fitting at a fixed part 3c1 provided as a side projection on the horizontal piece portion 3c.

As illustrated in the external view of FIG. 5, each of the second terminals 4 includes a substrate connecting portion 4a to be soldered to the mounting board P2, a vertical piece portion 4b extending in the height direction on the front side of the housing 2, a base portion 4c extending rearward from the vertical piece portion 4b, and a spring piece portion 4d extending upward from the base portion 4c.

The base portion 4c is disposed in the corresponding second-terminal attachment groove 2c1 of the housing 2. The base portion 4c has a projection-like fixed piece 4c1 to be fixed to the second-terminal attachment groove 2c1. A movable piece 4c2 continuously extends from the fixed piece 4c1. The movable piece 4c2 turns on a connecting portion to the fixed piece 4c1 in a direction away from the bottom surface 2e5 of the fitting chamber 2e. Since the base portion 4c is disposed with the fixed piece 4c1 and the movable piece 4c2 in contact with the bottom surface 2e5 of the fitting chamber 2e, the total height of the connector 1 is kept down. For example, if the base portion 4c is raised from the bottom surface 2e5, the height of the spring piece portion 4d in the upward direction is increased, and the total height of the housing 2 becomes large. However, such a problem is not caused in the embodiment.

The spring piece portion 4d is provided as a spring extending upward from the bottom surface 2e5 of the fitting chamber 2e. The spring piece portion 4d is S-shaped in side view, as illustrated in FIG. 5. Specifically, the spring piece portion 4d includes, in order from the lower side, a first bent part 4d1 bent from the movable piece 4c2 toward the opening 2e1 of the fitting chamber 2e, an extending part 4d2 extending from an end portion of the first bent part 4d1 toward the opening 2e1, a second bent part 4d3 bent from an end portion of the extending part 4d2 close to the opening 2e1 toward the depth side of the fitting chamber 2e, and a contact part 4d4 to be in conductive contact with a contact portion of the hard substrate P1.

In this way, the spring piece portion 4d ensures a large spring length by connecting the first bent part 4d1 and the second bent part 4d3, which are bent to face each other, by the extending part 4d2. Since the movable piece 4c2 can also function as a spring, the spring length is further increased. Thus, the contact part 4d4 can be softly displaced, and this reduces the insertion force for the hard substrate P1.

As viewed from the front side, the right and left side walls 2b are provided with fixing metals 5 to be soldered to the mounting board P2.

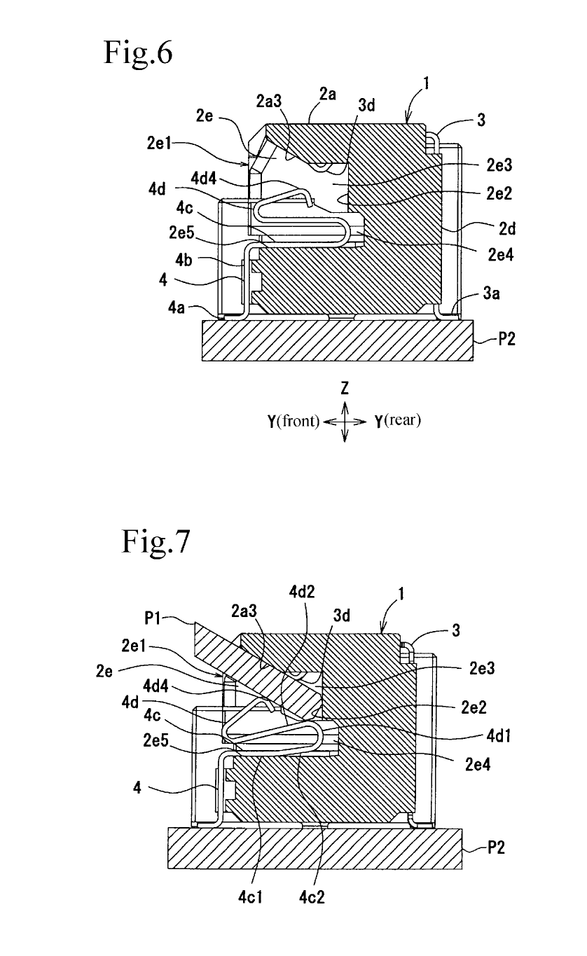

### Fitting of Hard Substrate P1 in Connector 1 (FIGS. 6 to 9)

Next, a description will be given of a method for fitting the hard substrate P1 in the connector 1. Before the hard substrate P1 is fitted, the connector 1 is mounted on the mounting board P2, as illustrated in FIG. 6.

As illustrated in FIG. 7, the hard substrate P1 is obliquely inserted from the opening 2e1 of the fitting chamber 2e. The hard substrate P1 is pressed by the spring piece portion 4d of each second terminal 4, is guided by the insertion guide surface 2a3, and is inserted into the fitting chamber 2e until its leading end comes into contact with the depth wall 2e2.

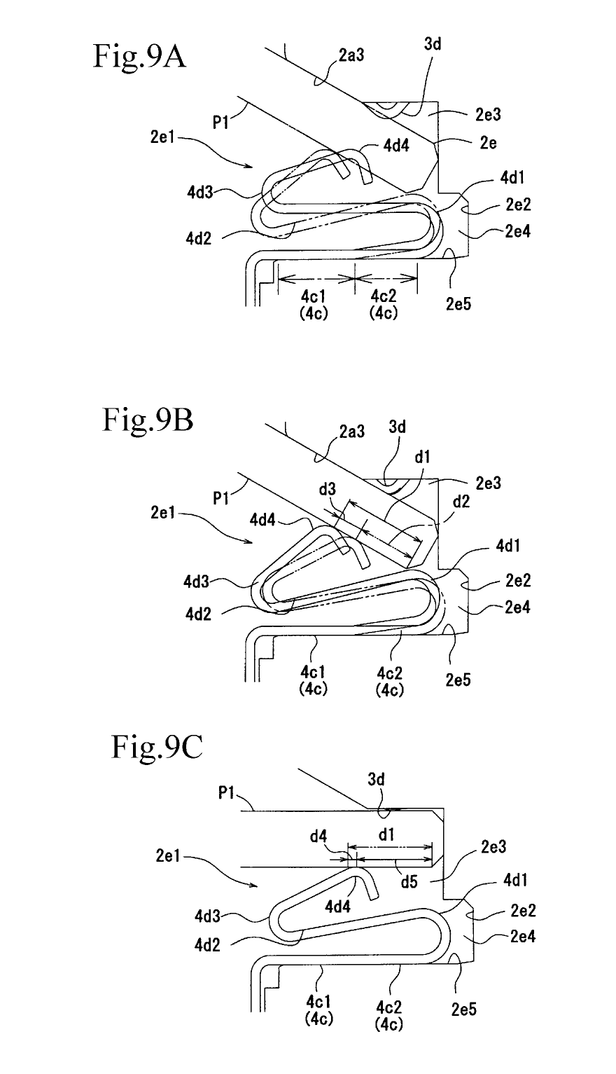

At this time, the contact part 4d4 of the second terminal 4 is turned and displaced to move toward the opening 2e1 of the fitting chamber 2e from the state of FIG. 6 to the state of FIG. 7, as shown by a solid line and a two-dot chain line in FIG. 9A. First, this is caused because the second bent part 4d3 is turned and displaced downward toward the opening 2e1 on the first bent part 4d1 when the contact part 4d4 is pressed downward by the hard substrate P1. Secondly, this is caused because the movable piece 4c2 is turned and displaced upward on the fixed piece 4c1 in the direction away from the bottom surface 2e5 of the fitting chamber 2e.

The contact part 4d4 can be turned and displaced in sliding contact with the hard substrate P1 toward the opening 2e1 of the fitting chamber 2e by a superposition effect of these two turns. At this time, since the contact part 4d4 can be turned and displaced by utilizing the sum of the lengths of the spring piece portion 4d and the movable piece 4c2 as the spring length, the second terminal 4 is softly displaced. This reduces the insertion force for the hard substrate P1 and enhances connection operability.

As illustrated in FIG. 9B, an excellent wiping effect is also exerted because a distance d1 for which the contact part 4d4 is in sliding contact with the hard substrate P1 can be increased by the above-described two turns. That is, FIG. 9B compares the contact part 4d4 (solid line) when the movable piece 4c2 is turned and displaced and the contact part 4d4 (two-dot chain line) when the movable piece 4c2 is not turned and displaced in the state in which the hard substrate P1 is inserted. When the movable piece 4c2 shown by the solid line is turned and displaced, the contact part 4d4 turns toward the opening 2e1. Hence, the distance d1 of sliding contact with the hard substrate P1 can be made longer by a distance d3 than a distance d2 when the movable piece 4c2 shown by the two-dot chain line is not turned and displaced. Therefore, in the connector 1, when a foreign substance, such as substrate residues, is attached to the hard substrate P1, the contact part 4d4 can wipe off the foreign substance over a wide range along the length direction (fitting direction) of the terminal of the hard substrate P1. Hence, high reliability of contact with the hard substrate P1 can be obtained.

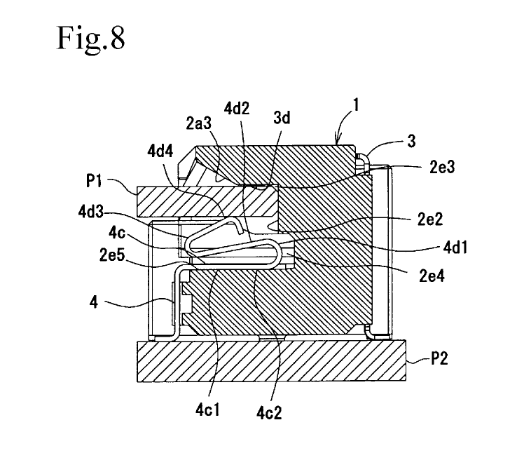

Next, the hard substrate P1 is turned from the inserted state of FIG. 7 to the horizontal state of FIG. 8. At this time, the hard substrate P1 presses the contact part 4d4 to turn and displace the movable piece 4c2 until the movable piece 4c2 comes into contact with the bottom surface 2e5 of the fitting chamber 2e, and also presses the contact portion 3d of the first terminal 3 upward. Thus, the hard substrate P1 is brought into conductive contact with the first terminal 3 and the second terminal 4.

In the fitting state in which the hard substrate P1 is turned to the horizontal position, the contact position of the contact part 4d4 with the hard substrate P1 is returned by a distance d4 from the contact position shown by the solid line in FIGS. 7 and 9B toward the leading end of the hard substrate P1, as illustrated in FIG. 9C. In this case, the effective fitting length is a distance d5. Therefore, when the hard substrate P1 is inserted, as illustrated in FIG. 9B, the contact part 4d4 can exert the wiping effect beyond the contact position in the fitting state of FIG. 9C. Therefore, the contact part 4d4 can achieve highly reliable conductive contact by contact with the contact surface of the hard substrate P1 from which the foreign substance has already been removed by wiping.

### Modification of Embodiment

The movable piece 4c2 of the base portion 4c is in contact with the bottom surface 2e5 of the fitting chamber 2e in the state in which the above-described connector 1 of the embodiment is not fitted to the hard substrate P1. However, the movable piece 4c2 may be separate from the bottom surface 2e5 beforehand by being inclined with respect thereto.

While the connector 1 of the embodiment is disposed so that the contact portion 3d projects in the fitting chamber 2e beyond an extension line of the insertion guide surface 2a3 of the upper wall 2a (see FIG. 9A), it can be provided not to cross the extension line. In the case in which the contact portion 3d is located beyond the extension line of the insertion guide surface 2a3, when the hard substrate P1 is inserted along the insertion guide surface 2a3, it touches the contact portion 3d and needs to be inserted while pressing and displacing the contact portion 3d. This increases the insertion force. However, when the contact portion 3d is disposed not to project into the fitting chamber 2e beyond the extension line of the insertion guide surface 2a3 of the upper wall 2a, even when the hard substrate P1 is inserted along the insertion guide surface 2a3, it does not touch the contact portion 3d. Hence, the hard substrate P1 can be inserted with light force.

While the number of poles of the connector 1 of the above-described embodiment is 230, it may be other numbers as long as the connector is required to reduce the insertion force for bending a plurality of terminals during insertion and removal of the flat conductor. However, in the connector 1 of the present invention, the terminals can be softly bent by using the total length of the spring piece portion 4d and the movable piece 4c2 as the spring length, as described above. Since this can reduce the insertion force for the flat conductor, the connector becomes more effective as long as the number of terminals increases.

What is claimed is:

1. A connector for a flat conductor, comprising:
a housing having a fitting chamber for the flat conductor; and
a terminal to be in conductive contact with the flat conductor inserted in the fitting chamber,
wherein the terminal includes
a base portion extending along a bottom surface of the fitting chamber from an open side of the fitting chamber to a depth side of the fitting chamber, and
a spring piece portion having a contact part to be in conductive contact with the flat conductor inserted in the fitting chamber and extending from the base portion above the bottom surface, and
wherein the base portion includes
a fixed piece fixed to the bottom surface on the open side, and
a movable piece configured to turn on an end portion of the fixed piece on the depth side in a direction away from the bottom surface.

2. The connector for the flat conductor according to claim 1,
wherein the spring piece portion has a first bent part bent from an end portion of the movable piece on the depth side toward the open side, and
wherein the first bent part serves as a turning fulcrum on which the contact part turns in sliding contact with the flat conductor toward the open side of the fitting chamber when the contact part is displaced toward the base portion by being pressed by the flat conductor inserted in the fitting chamber.

3. The connector for the flat conductor according to claim 2, wherein the spring piece portion further includes an extending part extending from the first bent part toward the open side, and a second bent part bent from an end portion of the extending part on the open side toward the depth side to be connected to the contact part.
